(19) United States
(12) Patent Application Publication
(10) Pub. No.: US 2015/0334076 A1
(43) Pub. Date: Nov. 19, 2015

(54) LOCATION ORGANIZATION AND SHARING SYSTEM AND METHOD

(71) Applicant: Mario R. Melton, Miami, FL (US)

(72) Inventor: Mario R. Melton, Miami, FL (US)

(21) Appl. No.: 14/713,726

(22) Filed: May 15, 2015

Related U.S. Application Data
(60) Provisional application No. 61/994,289, filed on May 16, 2014.

(51) Int. Cl. H04L 12/58; H04W 4/02

(52) U.S. Cl. CPC H04L 51/32; H04W 4/02

(57) ABSTRACT

A system and method is provided for organizing and sharing a location. The system may include an interface, a spot module, a photo module, a path module, and a comment module. The system may operate using a computerized device with a processor and memory. The system can further include an achievement module for associating achievements and related rewards with the location and an activity accomplished by a member of a community of members at that location.

### CROSS-REFERENCE TO RELATED APPLICATIONS

This application is a nonprovisional application of and claims priority from U.S. provisional patent application Ser. No. 61/994,289 filed on May 16, 2014. The foregoing application is incorporated in its entirety herein by reference.

### FIELD OF THE INVENTION

The invention is related to systems and methods for organizing and sharing locations. More particularly, the invention is related to systems and methods for electronically organizing and sharing locations over a network.

### BACKGROUND

People enjoy traveling around various locations. People also enjoy taking pictures of those locations. However, there is no easy solution for organizing pictures, sharing experiences, and commenting on travel locations. What is needed is a system to organize and share experiences from various locations to which a person travels. What is needed is a simple interface through which a user may organize and share information related to locations. What is needed is a method to organize and share experiences relating to various locations.

### SUMMARY

The system of the present invention facilitates organizing and sharing information relating to a location. The system includes an interface, through which a user may manipulate a spot module, photo module, path module, comment module, and achievement module. The system may be operated on a computerized device with a processor and memory. A method is provided for organizing and sharing information relating to a location.

The present invention advantageously provides a system to organize and share experiences from various locations to which a person travels. The present invention also advantageously provides a simple interface through which a user may organize and share information related to locations. The present invention advantageously provides a method to organize and share experiences for various locations.

Accordingly, the invention features a system for organizing and sharing a location, which includes modules, operated via a computerized system having a processor and memory, to create information relating to the location and to associate the information with the location. At least part of the information can be accessed by a community of members. The modules can include a spot module, a photo module, a path module, and a comment module. The spot module can create a spot indicative of the location. The photo module receives one or more photographs associable with the spot. The path module can create a path that includes at least the spot, and the path can be shared with at least part of the community. The comment module can receive commentary associable with the information. The system further includes an interface communicably connected to the modules to relay at least part of the information associated with the modules to a user. The interface can include a map on which at least part of the information is displayed. The system also includes a database communicably connected to the modules in which the information can be stored.

In another aspect, the invention can feature the interface further including a search bar to filter the information that is relayed.

In another aspect, the invention can feature the spot being designated as private or shared via the spot module, wherein the spot that is designated as private cannot be accessed by the community, and wherein the spot that is designated as shared is accessible by at least part of the community.

In another aspect, the invention can feature the information accessible by the member of the community being filterable by a condition, wherein the condition includes requiring the member requesting the information to be within a proximity of the location associated with the requested information.

In another aspect, the invention can feature the photo received via the photo module being stored in a photo bank associable with the spot and accessible by at least part of the community.

In another aspect, the invention can feature the location being determinable via signal triangulation.

In another aspect, the invention can feature the spot being associable with a permission, wherein the spot that is associated with the permission is modifiable only by the user authorized by the permission and the member authorized by the permission.

In another aspect, the invention can feature the modules further including an achievement module that associates an achievement with an activity of the member.

In another aspect, the invention can feature a reward being associable with the achievement that provides a benefit to the member of the community accomplishing the achievement.

The invention can also feature a system for organizing and sharing a location. The system can include modules, which are operated via a computerized system having a processor and memory, to create information relating to the location and to associate the information with the location. At least part of the information can be accessed by a community of members. The modules can include a spot module, a photo module, a path module, and a comment module. The spot module can create a spot indicative of the location. The photo module can receive a photograph and store the photograph in a photo bank. The photo can be associated with the spot and accessible by at least part of the community. The path module can create a path that includes at least the spot, and the path can be shared with the community and navigable by the member of the community. The comment module can receive commentary associable with the information. The system can further include an interface communicably connected to the modules to relay at least part of the information associated with the modules to a user. The interface can include a map on which at least part of the information is displayed. The information accessible by the member of the community can be filterable by a condition, and the condition can include a requirement that the member requesting the information be within a proximity of the location associated with the requested information. The spot can be designated as private or shared. If the spot is designated as private, it cannot be accessed by the community. If the spot is designated as shared, it is accessible by at least part of the community.

In another aspect, the invention can feature the interface further including a search bar to filter the information that is relayed.

In another aspect, the invention can feature the system having a database communicably connected to the modules, wherein the information is stored in the database.

In another aspect, the invention can feature the location being determinable via signal triangulation.

In another aspect, the invention can feature the spot being associable with a permission, wherein the spot that is associated with the permission is modifiable only by the user authorized by the permission and the member authorized by the permission.

In another aspect, the invention can feature the modules further including an achievement module that associates an achievement with an activity of the member. A reward can be associable with the achievement that provides a benefit to the member of the community accomplishing the achievement.

A method can be used for organizing and sharing a location, the method being performable via modules operated on a system having a processor and memory and accessible via an interface. The method can include the steps of: (a) creating information relating to the location, the information including a spot indicative of the location; (b) providing a photo module for receiving a photo to be associated with the spot; (c) providing a path module for creating a path that includes at least the spot, the path being sharable with a community of members; (d) providing a comment module for receiving commentary associable with the information; (e) setting a level of accessibility for the information by at least part of the community; and (f) relaying at least part of the information associated with the modules to a user via the interface, wherein the interface can include a map on which at least part of the information is displayed. The information can be stored via a database communicably connected to the modules.

Another method of the invention can include, after step (a), the step of (g) designating the spot as private or shared. If the spot is designated as private, it cannot be accessed by the community. If the spot is designated as shared, it is accessible by at least part of the community.

Another method of the invention can include the information that is accessible by the member of the community being filterable by a condition. The condition can include requiring the member requesting the information to be within a proximity of the location associated with the requested information. The condition can be receivable via a search bar of the interface.

Another method of the invention can include step (b) further including storing the photo that is received in a photo bank associable with the spot and accessible by at least part of the community.

Another method of the invention can include the step of (h) associating an achievement with an activity of the member. A reward can be associable with the achievement that provides a benefit to the member of the community accomplishing the achievement.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a screenshot diagram of the interface, according to an embodiment of the present invention.

FIG. 2 is a diagram illustrating various screens of a spot module, according to an embodiment of the present invention.

FIG. 3 is a diagram illustrating various screens of a photo module, according to an embodiment of the present invention.

FIG. 4 is a diagram illustrating various screens of a path module, according to an embodiment of the present invention.

FIG. 5 is a diagram illustrating various screens of a comment module, according to an embodiment of the present invention.

FIGS. 6A and 6B are schematic diagrams illustrating one process of the system for creating a path.

FIG. 7 is a flow chart showing an example of a process for creating an achievement.

FIG. 8 is a flow chart showing an example of a process for accomplishing an achievement.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties to be obtained.

The invention provides a location organization and sharing system and method that includes an interface and various modules. The system is operable on a computerized device with a processor and memory, which may include outputs such as a display and inputs such as buttons and a touchscreen. The modules may include, but should not be limited to, a spot module, a photo module, a path module, a comment module, and an achievement module. Each of these modules will be discussed in detail below.

The system is operable on a computerized device with a processor and memory. The computerized device may communicate through a network, such as a wireless network, a device connected to the network, or another device that would be apparent to skilled artisans. The system may be operable over a local area network, a cellular network, or another network that would be apparent to a skilled artisan.

An illustrative computerized device will now be discussed. The computerized device may include a processor, memory, network controller, and optionally an input/output (I/O) controller. Skilled artisans will appreciate additional embodiments of a computerized device that may omit one or more of the aforementioned components or include additional components without limitation. The processor may receive and analyze data. The memory may store data, which may be used by the processor to perform the analysis. The memory may also receive data indicative of results from the analysis of data by the processor.

The memory may include volatile memory modules, such as random access memory (RAM), or non-volatile memory modules, such as flash-based memory Skilled artisans will appreciate the memory to additionally include storage devices, such as, for example, mechanical hard drives, solid state drives, and removable storage devices.

The computerized device may also include a network controller. The network controller may receive data from other components of the computerized device to be communicated with other computerized devices via a network. The communication of data may be performed wirelessly. More specifically, without limitation, the network controller may communicate and relay information from one or more components of the computerized device, or other devices and/or components connected to the computerized device, to additional connected devices. Connected devices are intended to include data servers, additional computerized devices, mobile computing devices, smart phones, tablet computers, and other electronic devices that may communicate digitally with another device. In one example, the computerized device may be used as a server to analyze and communicate data between connected devices.

The computer may also include an I/O interface. The I/O interface may be used to transmit data between the computerized device and extended devices. Examples of extended devices may include, but should not be limited to, a display, external storage device, human interface device, printer, sound controller, touchscreen, or other components that would be apparent to a person of skill in the art. Additionally, one or more of the components of the computerized device may be communicatively connected to the other components via the I/O interface.

The components of the computerized device may interact with one another via a bus. Those of skill in the art will appreciate various forms of a bus that may be used to transmit data between one or more components of an electronic device, which are intended to be included within the scope of this disclosure.

The computerized device may communicate with one or more connected devices via a network. The computerized device may communicate over the network by using its network controller. More specifically, the network controller of the computerized device may communicate with the network controllers of the connected devices. The network may be, for example, the internet. As another example, the network may be a localized network connection. However, skilled artisans will appreciate additional networks to be included within the scope of this disclosure, such as intranets, local area networks, wide area networks, peer-to-peer networks, and various other network formats. Additionally, the computerized device and/or connected devices may communicate over the network via a wired, wireless, or other connection, without limitation.

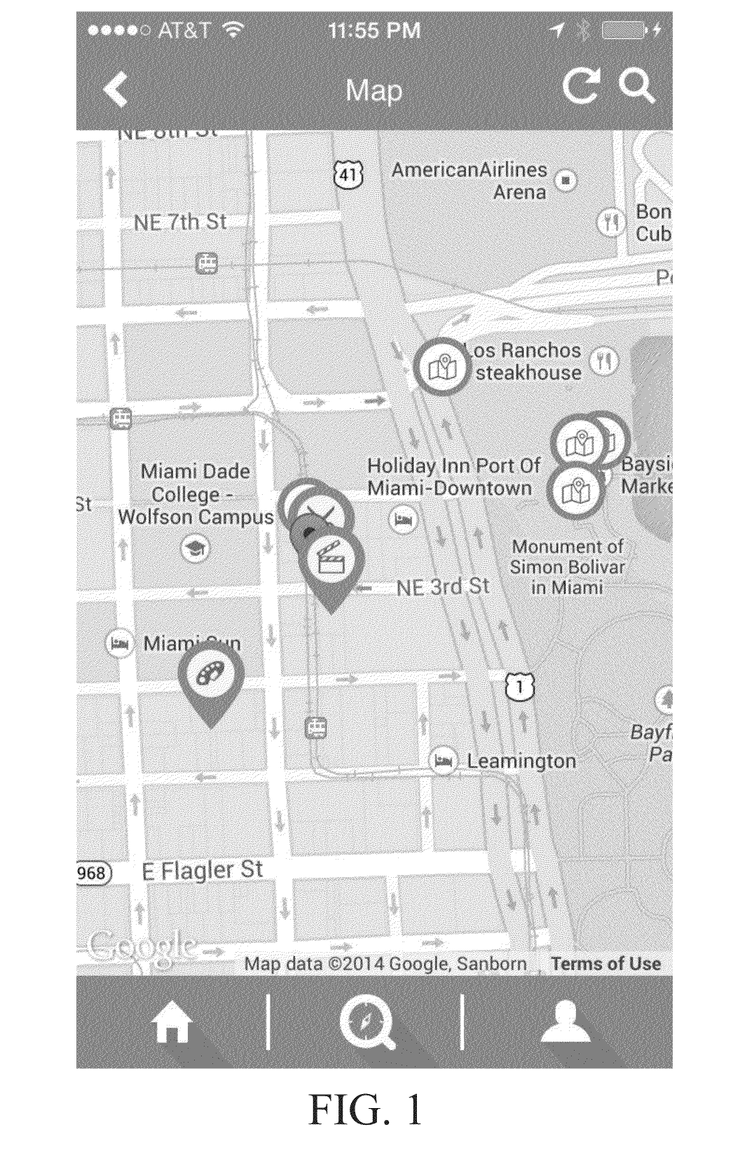

Referring to FIG. 1, the interface will now be discussed. Generally, the interface graphically lays out information relating to the various modules of the system. The interface also provides access to the various modules, a summary of spots created using the modules, and a general hub for interfacing with the system and its included components. Using the interface, users may access and manipulate a spot module, a photo module, path module, a comment module, and/or an achievement module. The may include a map, by which a user can see content added by the user and/or content provided by other users in having access to the network.

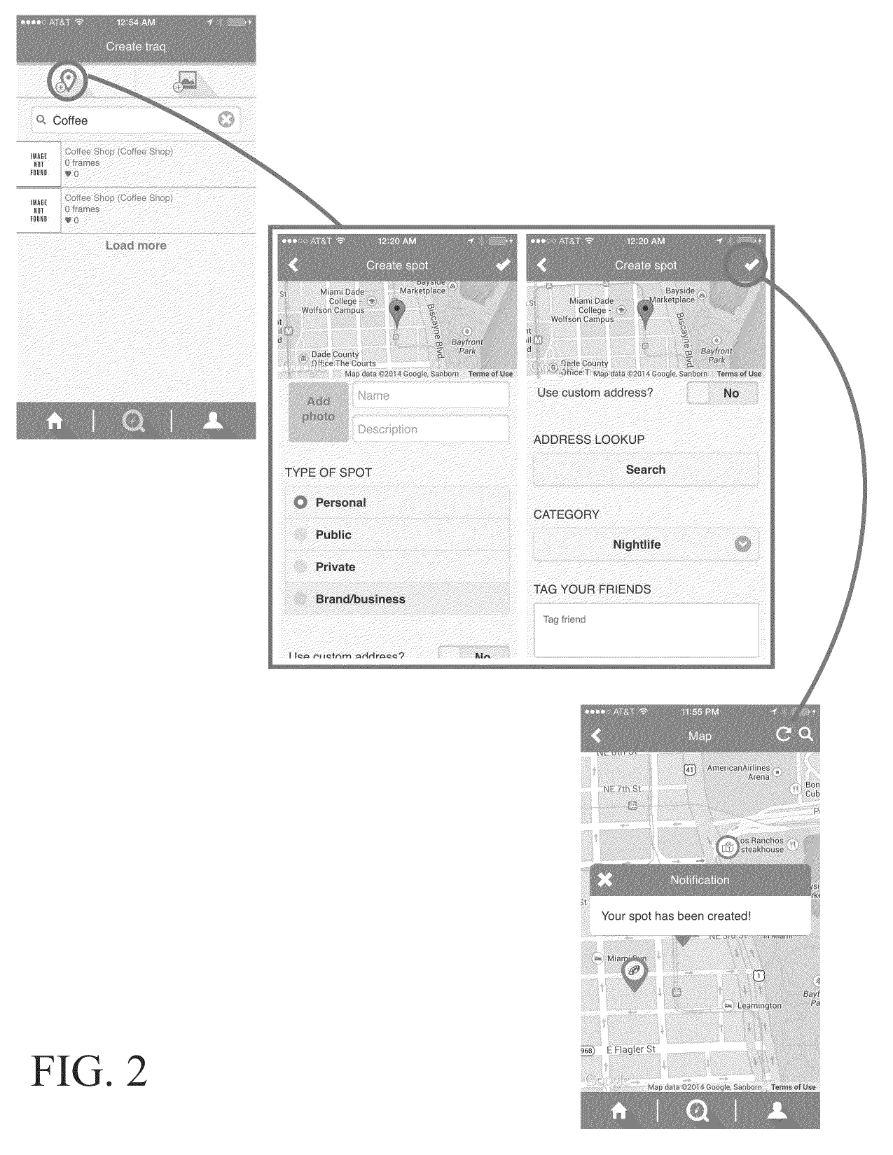

Referring to FIG. 2, the spot module will now be discussed. Using this spot module, a user may create spots indicative of a location. The spot module may be accessed using the interface, for example, by engaging a button programmed to access the spot module. Using the spot module, a user may navigate various screens to indicate a location in the system. Information about the spot may be stored electronically, for example, in a database. Information about the spot may include a user's current location, latitude, longitude, signal triangulation, GPS details, address, and other identifying information. Users may also manually input an address to create the spot.

A spot may be designated with additional parameters or tags. For example, the user may designate a certain spot as being private. A private spot may be set as not shared with other users. This designation may be indicated upon creation or subsequent modification of a spot.

A spot may operate as a community editable photo bank. For example, any user operating the system with appropriate permissions may upload a photo to a spot. Permissions may define a level of accessibility to information. Additionally, a user or creator of the spot may define conditions that affect the permissions. As an example, permissions may require that a user uploading a photo be within the vicinity of the spot. Skilled artisans will appreciate that parameters defining the vicinity are customizable by an architect of the system and/or a user.

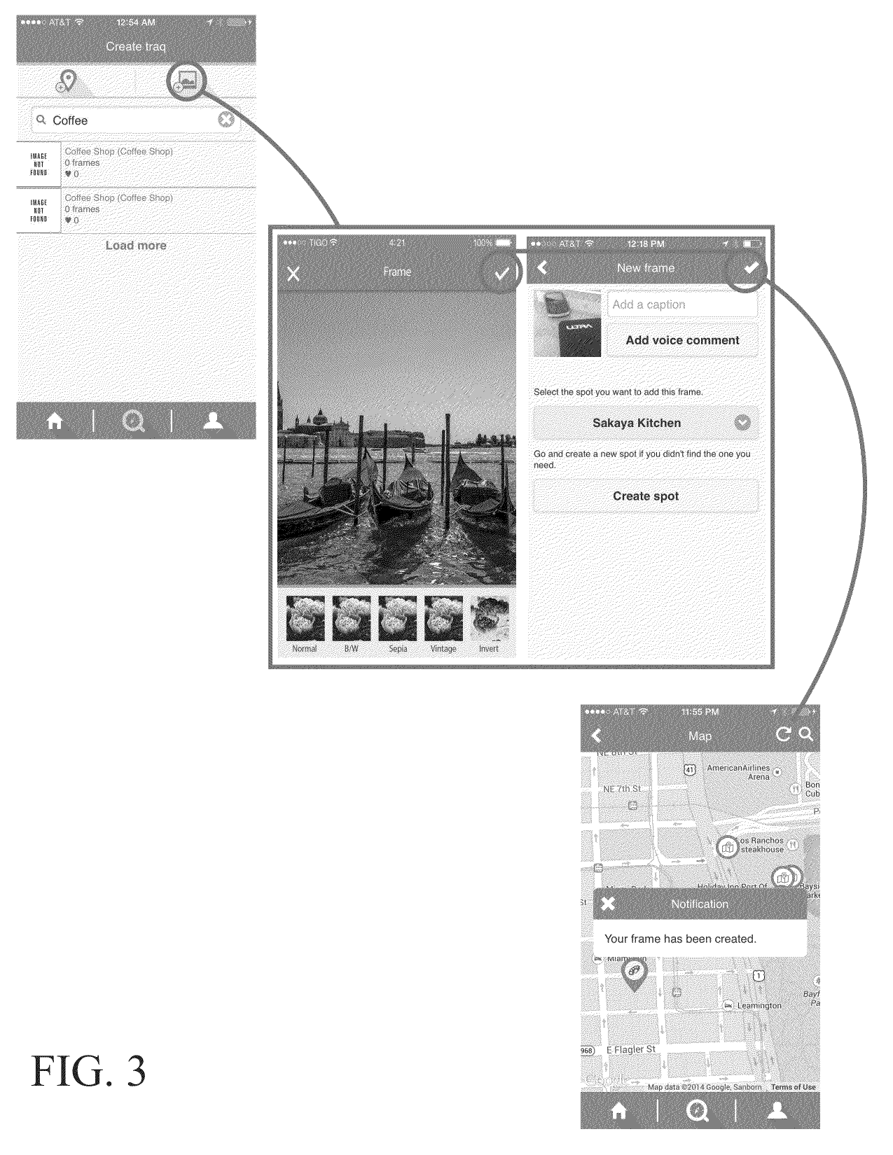

Referring to FIG. 3, the photo module will now be discussed. The photo module may be use to upload photos to the system to be associated with one or more spots. The photos may be stored in photo banks, which may also be associated with the spots. Using the system, a user may capture a photo and upload that photo to a spot within given permissions, for example, within its vicinity. By providing users with the direct path upload photos to a spot, the system advantageously removes the necessity for attaching hashtags, keywords, and other identifying labels.

After a user has indicated that he or she wishes to upload a photo to a spot, the user may operate the photo module to detect one or more acceptable spots to receive the photo. An acceptable spot may be a spot that is compliant with permissions of the system and/or the spot. For example, a user may only be provided spots for uploading his or her photo that are within a definable vicinity of the user. There, the available spots to which the photo may be uploaded may populate the interface in response to a user action, for example, choosing a “select spot” selection from the photo module screen. After a user captures the photo and uploads it to the photo bank, the photo may then appear as a stream of photos that have been uploaded that spot.

When a user selects a spot from the map or list, a new screen may open to display one or more photos uploaded to spot. The user may then browse or otherwise view the photos from the screen. In one embodiment, the photos are shown in a scrollable format.

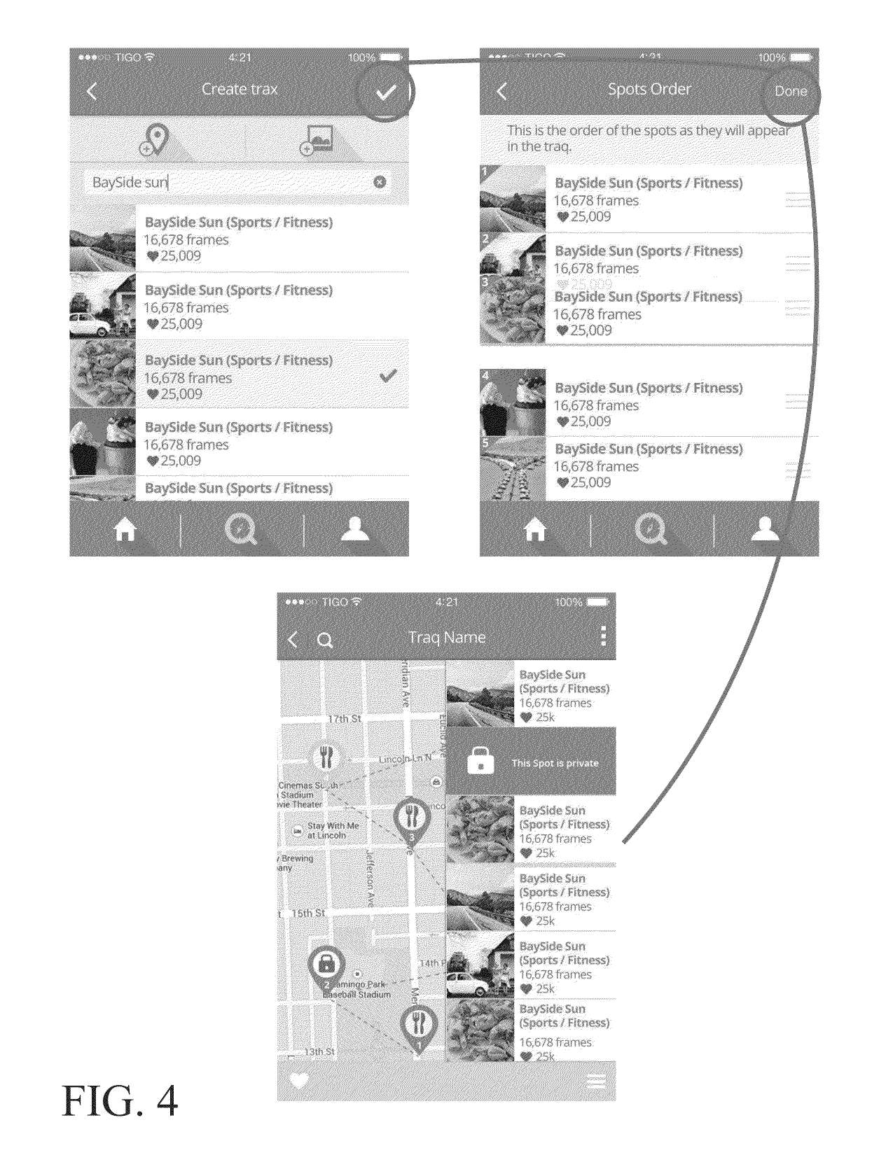

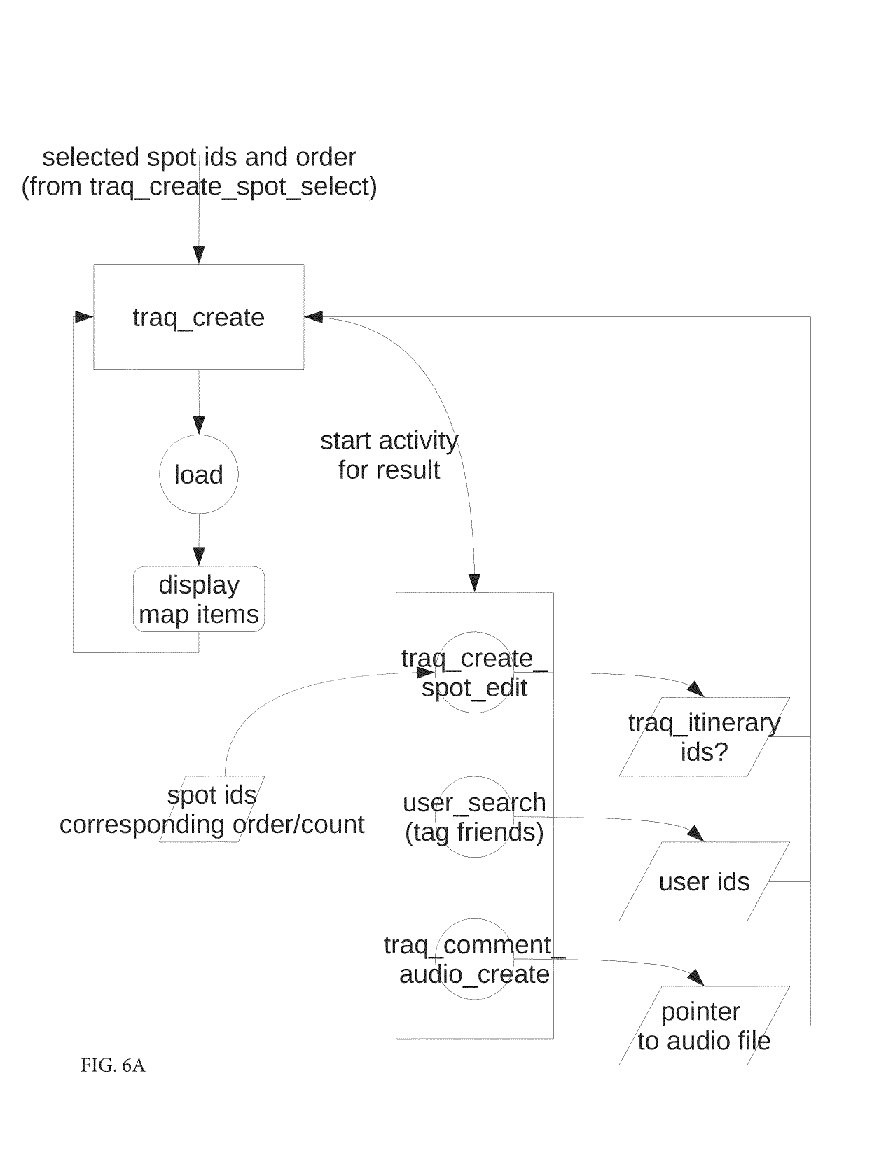

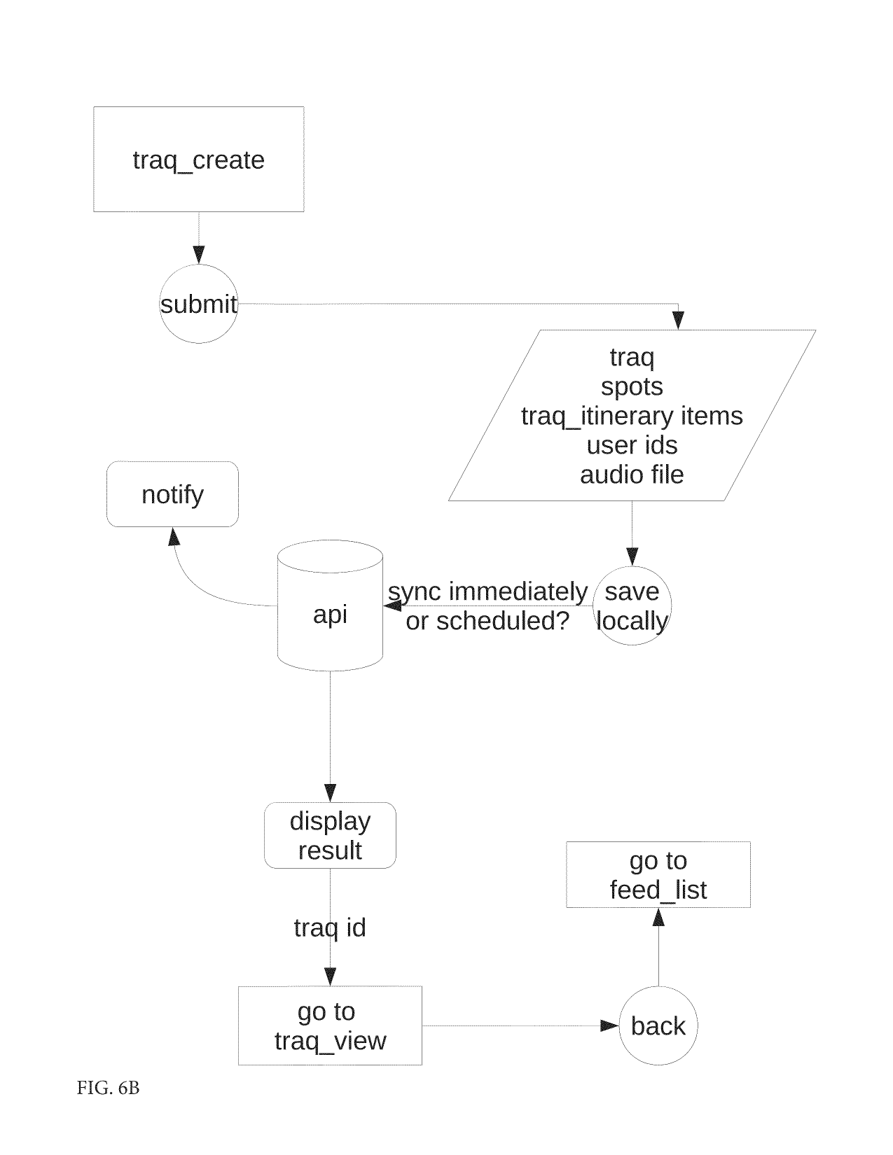

Referring to FIGS. 4, 6A, and 6B, the path module will now be discussed. The path module may be used to define paths or “traqs” associable with one or more spots. Paths and “traqs” may be used interchangeably throughout this disclosure. Skilled artisans should appreciate that use of the term “traq” is intended to describe a path navigable by a user. A path or traq may link spots to one another. The user may navigate to the path module by interacting with a button on the interface. For example, a user may select a center navigation button at the bottom of the application window, which may be presented as a compass, magnifying glass, or other recognizable icon.

After initiating the path module, a first screen may appear showing a list of spots within a given parameter, such as within permissible vicinity. The user may select as few or as many of these spots as he or she desires. If there additional spots a user wants to add to a path or traq, the user may engage a search bar and enter a keyword, title, or similar identifier to locate the spot. The system may provide the user with a list of available spots with a search keyword or title from which the user may select a desired spot.

The list of spots based on a keyword search may not be required to correspond with an immediate vicinity. A path may incorporate spots within a user's immediate vicinity, as well as spots anywhere else. Once the user has created a path or traq, it may be published, pushed into a newsfeed, and/or immediately viewable on a map. Once other users see the path or traq item in his or her newsfeed, or on the map, the other user may select the path to see corresponding information. The other user may “reload,” or access your data relating to the path and/or contribute information to the path. Reloading a traq may add the traq to users profile or hub, which may be saved for future completion (following someone else's path or traq).

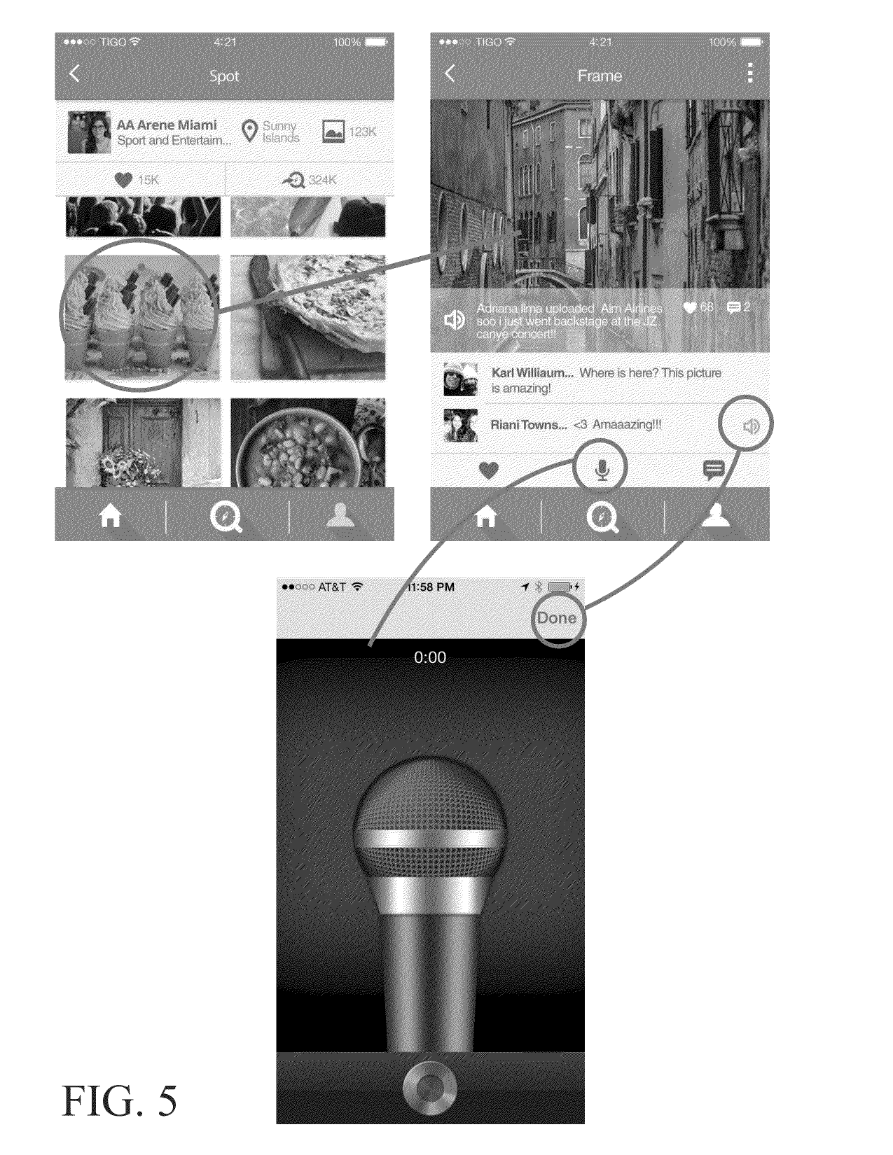

Referring to FIG. 5, the comment module will now be discussed. The comment module may be use to add notes and other information to a spot or traq. Comments may be provided via text, voice, audio recordings, video recordings, or other forms of commenting. A comment may be attached to virtually any piece of shareable content provided by the system. For example, typed and/or voice comments may be attached to a photo posted to the system. Similarly, comments may also be attached to or associated with spots and traqs. In one embodiment, a voice counter may be accompanied by a play counter so that a user looking at a photo, frame, traq, or spot, may see which voice comments are popular based on play count.

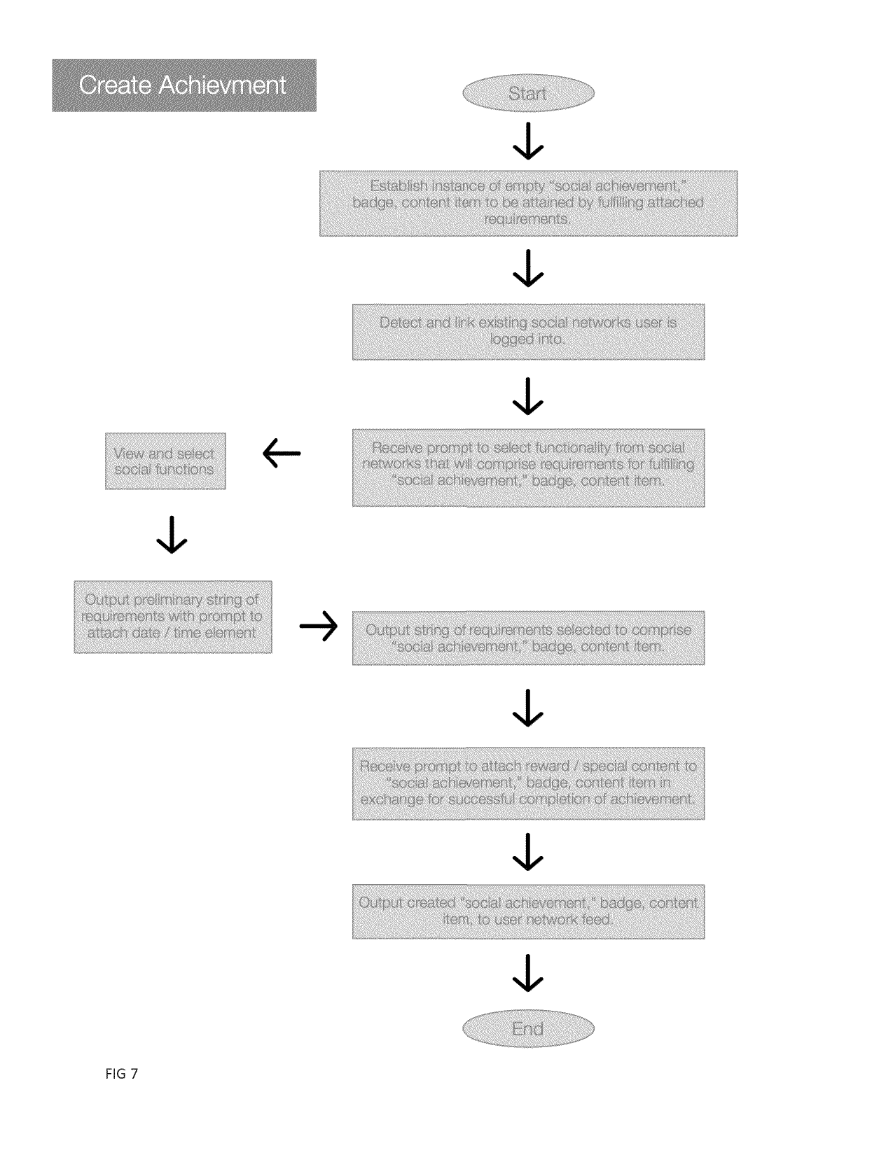

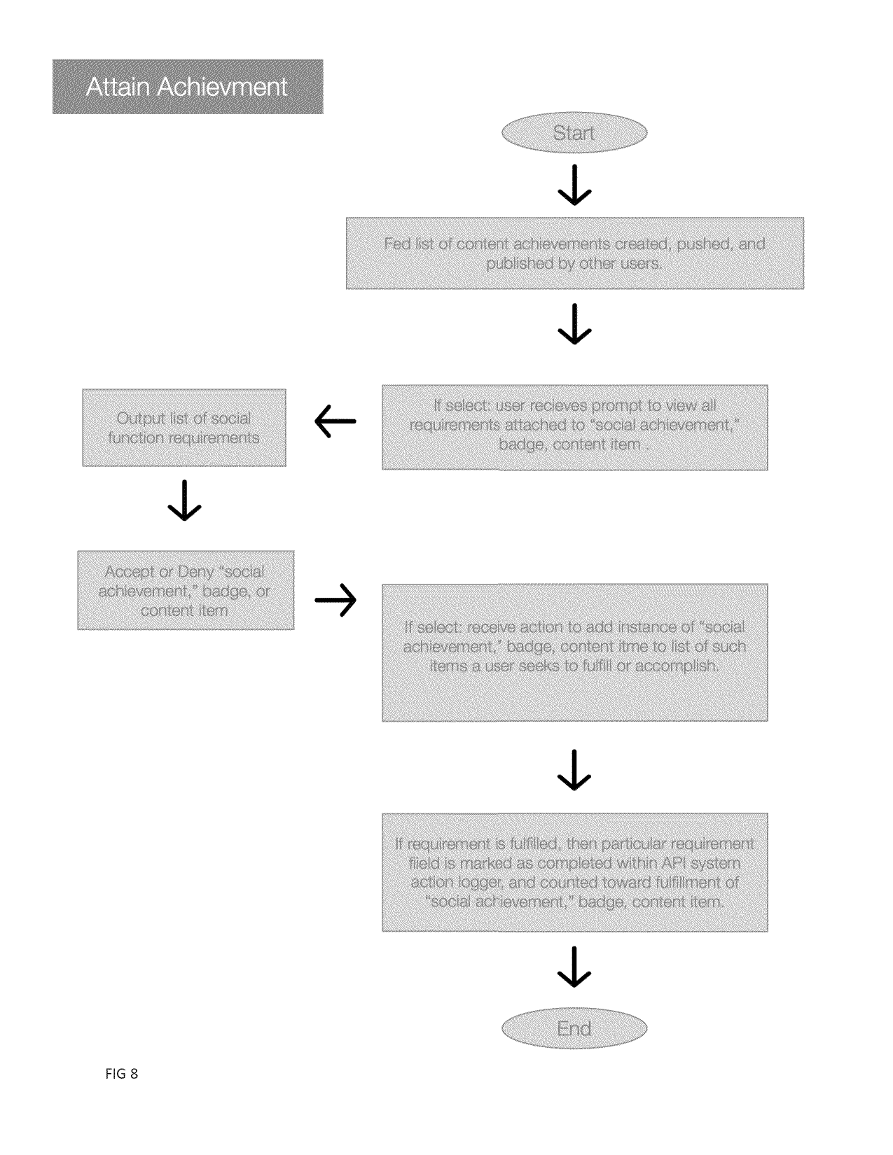

The achievement module will now be discussed. FIGS. 7 and 8 include flow charts showing examples of processes that can be used by the system to create an achievement and to accomplish the achievement, thereby resulting in the provision of a reward. The achievement module may be included to incentivize continued use of the system. The achievement module may include various functional features and tools to incentivize a user. Examples of such tools may relate to activities including spot creation, path creation and uploading, traq creation, and commenting. Achievements may be associated with each of the tools, providing a sense of accomplishment for using the system. The tools may be mixed and matched, each providing different requirements to accomplish an achievement, quest, or acquire a title.

Achievements, quests, and titles may be user-created. User may define the parameters of an achievement, quest, or title that he or she creates. A reward may be associable with the achievement that may provide a benefit to the member of the community accomplishing the achievement. For example, if the reward for a particular achievement, quest, or title is “X” badge, “Y” title, or “Z” coupon, it can be determined by the user creating the reward. The reward may provide a benefit to a user and/or member of the community. Achievements, quest, titles, rewards, and other incentives may be displayed to a user via the interface, such as on a map. The reward may be money, goods, services, credits, discounts, coupons, or other things of value, or the reward may be physical or online badges, honorary titles, rankings, standings, or other indicia associated with accomplishing the achievement, a number of achievements, a percentage of achievements, or a particular set of achievements.

According to an embodiment of the present invention, a method is provided for organizing and sharing a location performed using a computerized device with a processor and memory. The method may include manipulating an interface, which may include the modules discussed above. Manipulating the interface may include manipulating a spot module, manipulating a photo module, manipulating a path module, and manipulating a comment module. Additionally, the method may include manipulating an achievement module.

In one embodiment of the present invention, a method is provided for organizing and sharing a location. The method may be performable via modules operated on a system with a processor and memory. The method may accessible and/or performable via an interface. The method may include creating information relating to the location. The information may include a spot indicative of the location. The method may additionally include providing a photo module for receiving a photo to be associated with the spot. Also, the method may include providing a path module for creating a path that includes at least the spot. The path may be sharable with a community of members. Moreover, the method may include providing a commentary module for receiving commentary associable with the information. The method may include setting a level of accessibility for the information by at least part of the community. Furthermore, the method may include relaying at least part of the information associated with the modules to a user via the interface. The interface may include a map on which at least part of the information is displayed. The information may be stored via a database communicably connected to the modules.

The method may optionally include the designating the spot as private or shared. The spot that is private may be inaccessible by the community. The spot that is designated as shared may be accessible by at least part of the community. The method may also optionally include the information being filterable by a condition. The condition may include requiring the member requesting the information being within a proximity of the location associated with the requested information. The condition is receivable via a search bar of the interface.

The method may optionally include storing the photo that is received in a photo bank associable with the spot and accessible by at least part of the community. The method may also optionally include associating an achievement with an activity of the member. As previously indicated, the reward may be associable with the achievement that may provide a benefit to the member of the community accomplishing the achievement.

In an embodiment of the present invention, the interface may initially present users with a login in screen. The interface may additionally provide prospective users with a sign up screen. The interface may include a traqs feed, search, and memory map screen. The Traqs screen may allow users to scroll down and display a search option. Interacting with a map icon may lay out traqs from the feed on to a map. Additionally, interacting with a traq on the may open a tooltip that has additional details. Interacting with the tooltip may navigate a user to the traq screen.

The interface may include a traqs feed and may allow a user to create a traq. Interacting with a traq of another member of the community. A tooltip may be displayed moving from one spot to another spot. An edit option may allow a user to join another person's traq or to “delete” and label items and/or spots as “can't make it” if wanted, not to move the order. The list of spots that pops up by default may be a mix of spots that have been created by a user relative to an area. The area may be in proximity to the user. The list of spots may additionally display locations curated from another source, for example, Google places. A user my want to select any of the spots for their traq. Spots sourced by the system may additionally display locations from the other sources. If a user selects a spot from the other sources and the system does not have information relating to the spot, the system may merge at least part of the information from the other source into the database.

The interface may synchronize with another data management platform, for example, iCal, Google apps, Outlook, and other platforms.

The interface may allow a user to drag and drop items into positions they choose on a map. Date and time issues may be resolved substantially automatically. Interacting with buttons of the interface may activate other features of the system. Additionally, interacting with a spot on the map may activate a tooltip and/or cause the tooltip to be displayed to the user.

Interacting with a spot from the feed, map, and/or from a search may take a member to a spot page. The spot page may display the frames created and uploaded to the spot, and the number of traqs that the spot has been added to by members. A “my hub” icon may be displayed if the spot is owned by the user. Interacting with a create spot icon may allow a user to create his or her own spot as opposed to selecting one from the list of locations derived from another source.

Interacting with a photo icon from the feed via a spot page may take a member of the community to a frame. Here, the member may create written comments, voice comments, and/or other commentary. Sliding a comment to an edge of the screen may allow a member to delete a comment that he or she left. If the member is the user that created the photo, the user may remove another member's comment. Once a user takes a photo, he or she may add a caption, tag friends, select the spot to associate the photo with, or create a new spot to upload the photo to. Users may not be required to select a spot or create one if they do not wish to. If the user does want to upload the photo to a spot, he or she may engage in associated button of the interface, such as in “select spot” button, to scroll through a list of nearby and/or available spots. The user may additionally share his or her photo on other networks, for example, Facebook or Twitter.

The interface may include a “my request” tab respective, which may be displayable via the hub screen. The hub screen may include account and/or profile details set as private, and be accessible to other members only if the user approves such other members wishing to follow them. If a user engages their “my tags” label because they have received a notification, tags that he or she accumulated may populate the scrollable window. The user may have the ability to view and/or decline/remove the tag. When a user engages the “my spots” label, substantially all the spots the user has created may be displayed and may be scrollable with a respective category icons, number of photos uploaded by them, or by other members that had visited their spot and uploaded a photo. When a user interacts with their “my photos” label in the hub screen, substantially all photos the user has taken may populate, with a number of likes and/or comments, on the layer of the screen.

A setting screen of the interface may be provided to the user, through which the user may change his or her name, picture, information, permissions, profile accessibility, and other attributes via the setting screen. The user may optionally access terms and privacy policies via a screen of the interface.

Hubs associated with members of the community may be viewed by other members of the community. Looking at another member's hub may be similar to looking at the hub of the user. However, various label titles, buttons, follow options, and headlines may differ on a member's hub from the hub of the user. A lock screen may be displayed to a user attempting to access the hub of a member that is private or otherwise selected not to share his or her member hub with the user.

According to an embodiment of the present invention, users of the system may connect and/or interact with other users via the network. For example, users can share spots, photos, paths, and other data using the interface and/or modules. The system may include a social aspect that facilitates and encourages interaction with other users.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for organizing and sharing a location comprising:
modules operated via a computerized system comprising a processor and memory to create information relating to the location and to associate the information with the location, at least part of the information to be accessed by a community of members, the modules comprising:
a spot module to create a spot indicative of the location,
a photo module through which a photo is receivable and associable with the spot, and
a path module to create a path that comprises at least the spot, the path being shared with at least part of the community;
a comment module to receive commentary associable with the information;
an interface communicably connected to the modules to relay at least part of the information associated with the modules to a user, the interface comprising a map on which at least part of the information is displayed; and
a database communicably connected to the modules;
wherein the information is stored in the database.

2. The system of claim 1, wherein the interface further comprises a search bar to filter the information that is relayed.

3. The system of claim 1, wherein the spot is designated as private or shared via the spot module, wherein the spot that is designated as private cannot be accessed by the community, and wherein the spot that is designated as shared is accessible by at least part of the community.

4. The system of claim 1, wherein the information accessible by the member of the community is filterable by a condition, and wherein the condition comprises requiring the member requesting the information to be within a proximity of the location associated with the requested information.

5. The system of claim 1, wherein the photo received via the photo module is stored in a photo bank associable with the spot and accessible by at least part of the community.

6. The system of claim 1, wherein the location is determinable via signal triangulation.

7. The system of claim 1, wherein the spot is associable with a permission, wherein the spot that is associated with the permission is modifiable only by the user authorized by the permission and the member authorized by the permission.

8. The system of claim 1, wherein the modules further comprise an achievement module that associates an achievement with an activity of the member.

9. The system of claim 8, wherein a reward is associable with the achievement that provides a benefit to the member of the community accomplishing the achievement.

10. A system for organizing and sharing a location comprising:
modules operated via a computerized system comprising a processor and memory to create information relating to the location and to associate the information with the location, at least part of the information to be accessed by a community of members, the modules comprising:
a spot module to create a spot indicative of the location,
a photo module through which a photo is received and stored in a photo bank, the photo being associated with the spot and accessible by at least part of the community,
a path module to create a path that comprises at least the spot, the path being shared with the community and navigable by the member of the community, and
a comment module to receive commentary associable with the information; and
an interface communicably connected to the modules to relay at least part of the information associated with the modules to a user, the interface comprising a map on which at least part of the information is displayed; and
wherein the information accessible by the member of the community is filterable by a condition;
wherein the condition comprises a requirement that the member requesting the information be within a proximity of the location associated with the requested information;
wherein the spot is designated as private or shared;
wherein the spot that is designated as private cannot be accessed by the community;
wherein the spot that is designated as shared is accessible by at least part of the community.

11. The system of claim 10, wherein the interface further comprises a search bar to filter the information that is relayed.

12. The system of claim 10, further comprising a database communicably connected to the modules, wherein the information is stored in the database.

13. The system of claim 10, wherein the location is determinable via signal triangulation.

14. The system of claim 10, wherein the spot is associable with a permission, wherein the spot that is associated with the permission is modifiable only by the user authorized by the permission and the member authorized by the permission.

15. The system of claim 10:
wherein the modules further comprise an achievement module that associates an achievement with an activity of the member; and
wherein a reward is associable with the achievement that provides a benefit to the member of the community accomplishing the achievement.

16. A method for organizing and sharing a location, the method being performable via modules operated on a system comprising a processor and memory and accessible via an interface, the method comprising the steps of:
(a) creating information relating to the location, the information comprising a spot indicative of the location;
(b) providing a photo module for receiving a photo to be associated with the spot;
(c) providing a path module for creating a path comprising at least the spot, the path being sharable with a community of members;
(d) providing a comment module for receiving commentary associable with the information;
(e) setting a level of accessibility for the information by at least part of the community; and
(f) relaying at least part of the information associated with the modules to a user via the interface, the interface comprising a map on which at least part of the information is displayed;
wherein the information is stored via a database communicably connected to the modules.

17. The method of claim 16, wherein after step (a) the method further comprises the step of:
(g) designating the spot as private or shared;
wherein the spot that is designated as private cannot be accessed by the community; and
wherein the spot that is designated as shared is accessible by at least part of the community.

18. The method of claim 16,
wherein the information accessible by the member of the community is filterable by a condition;
wherein the condition comprises requiring the member requesting the information to be within a proximity of the location associated with the requested information; and
wherein the condition is receivable via a search bar of the interface.

19. The method of claim 16, wherein step (b) further comprises storing the photo that is received in a photo bank associable with the spot and accessible by at least part of the community.

20. The system of claim 16, further comprising the step of:
(h) associating an achievement with an activity of the member;
wherein a reward is associable with the achievement that provides a benefit to the member of the community accomplishing the achievement.
